(19) United States
(12) Patent Application Publication
(10) Pub. No.: US 2025/0191096 A1
(43) Pub. Date: Jun. 12, 2025

(54) Deathcare-Servicing Applications for Coordinating Deathcare Services Selected for End-of-Life Events, and Methods, Systems and Devices Thereof

(71) Applicant: Park Lawn Capital Limited, Inc., Houston, TX (US)

(72) Inventors: Jeff Parker, Houston, TX (US); Duane Ferrell, Huffman, TX (US)

(21) Appl. No.: 18/593,759

(22) Filed: Mar. 1, 2024

Related U.S. Application Data
(60) Provisional application No. 63/607,510, filed on Dec. 7, 2023.

(51) Int. Cl. G06Q 50/18

(52) U.S. Cl. CPC G06Q 50/186

(57) ABSTRACT

A deathcare-servicing application configuration is provided. The deathcare-servicing application receives a request to create a deathcare-servicing ledger for an event related to a deceased. Based on the request, the deathcare-servicing application identifies particular data objects corresponding to the deathcare provider. Based on the particular data objects identified, the deathcare-servicing application identifies a set of items for selection by a user of the deathcare-servicing application. Responsive to a user selection of a first item of the set of items, the deathcare-servicing application identifies a particular ledger entry from a plurality of ledger entries mapped to the first item, where the particular ledger entry is identified based on other data received by the electronic device about the end-of-life event. And the deathcare-servicing application provides the particular ledger entry to the deathcare-servicing ledger, where the deathcare-servicing ledger is configured to identify information relevant to performing all of a set of deathcare-servicing software operations.

### PRIORITY AND RELATED APPLICATIONS

This application claims priority to U.S. Provisional Patent Application No. 63/607,510, entitled “Deathcare-Servicing Applications for Coordinating Deathcare Services Selected for End-of-Life Events, and Methods, Systems and Devices Thereof” filed Dec. 7, 2023, which is hereby incorporated by reference in its entirety.

### TECHNICAL FIELD

This disclosure relates generally to deathcare-servicing applications, and more specifically to deathcare-servicing applications that include deathcare-servicing ledgers for managing items corresponding to deathcare-servicing items for end-of-life related events (e.g., passing of an individual).

### BACKGROUND

When an individual passes (or preemptive planning is undertaken for an individual's passing), typically, members of the family or friends of the individual meet with a member of the deathcare-services industry (e.g., a funeral director or funeral home coordinator at a funeral home or a sales counselor at a cemetery) to coordinate end-of-life events related to the death of the individual. The coordinator is often an experienced deathcare-services professional who understands the typical arrangements for such services, but likely does not have an adequate level of knowledge about all of the administrative requirements (e.g., legal considerations, accounting requirements, trusting requirements, commissioning structures) that can be implicated by the sale of such goods and/or services. Determinations regarding such administrative requirements can be highly fact specific (e.g., based on local rules for the jurisdiction) and/or can require highly specialized knowledge or expertise.

### SUMMARY

In the disclosed implementations, systems and methods are provided for efficiently and intuitively provisioning deathcare services and merchandise from a particular deathcare provider (e.g., funeral services, a right of interment, and/or a piece of physical merchandise (e.g., a casket, memorial, or marker)) for end-of-life by providing a deathcare-servicing application that allows for mapping particular deathcare-servicing items to a plurality of corresponding ledger entries, identification of which for a particular selection being based on other data provided to the deathcare-servicing application (e.g., customer profile data obtained about the customer and/or the end-of-life event prior to receiving the request from the customer to select one or more services of the end-of-life event).

To that end, in accordance with some implementations, a method is provided. The method is performed at an electronic device associated with a deathcare provider, the electronic device having one or more processors and memory, the memory storing instructions for causing presentation of a deathcare-servicing application. The method includes receiving a request to create a deathcare-servicing ledger for an end-of-life related event. The method includes, in accordance with receiving the request, identifying particular data objects corresponding to the deathcare provider. The method includes, based on the particular data objects identified as corresponding to the deathcare provider, identifying a set of items for selection by a user of the electronic device, wherein the set of items correspond to available deathcare services, right of interment, or merchandise items for the end-of-life event. The method includes, responsive to a selection by the user, a first item of the set of items, identifying a particular ledger entry from a plurality of ledger entries mapped to the first item, wherein the particular ledger entry is identified based on other data received by the electronic device about the end-of-life event. And, the method includes providing the particular ledger entry to the deathcare-servicing ledger for the end-of-life event, wherein the deathcare-servicing ledger is configured to identify information relevant to performing all of a set of deathcare-servicing software operations for coordinating fulfillment of the selection of the available deathcare service items for the end-of-life event.

In accordance with some implementations, an electronic device is provided. The electronic device includes one or more processors and memory storing one or more programs. The one or more programs include instructions for performing any of the methods described herein.

In accordance with some implementations, a non-transitory computer-readable storage medium is provided. The non-transitory computer-readable storage medium stores one or more programs for execution by an electronic device with one or more processors. The one or more programs comprise instructions for performing any of the methods described herein.

Thus, methods and associated devices and systems are provided for facilitating user interactions with a deathcare-servicing application.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings and specification.

FIG. 1 is a block diagram illustrating a deathcare-servicing system, in accordance with some implementations.

FIG. 2 is a block diagram illustrating an electronic device associated with a deathcare provider, in accordance with some implementations.

FIG. 3 is a block diagram illustrating a remote server of a deathcare-servicing system, in accordance with some implementations.

FIGS. 4A to 4G are sequence diagrams illustrating user interfaces and operations of an example deathcare-servicing application, in accordance with some implementations.

FIG. 5 is a flow diagram illustrating an example method performed by an example deathcare-servicing application, in accordance with some implementations.

### DETAILED DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

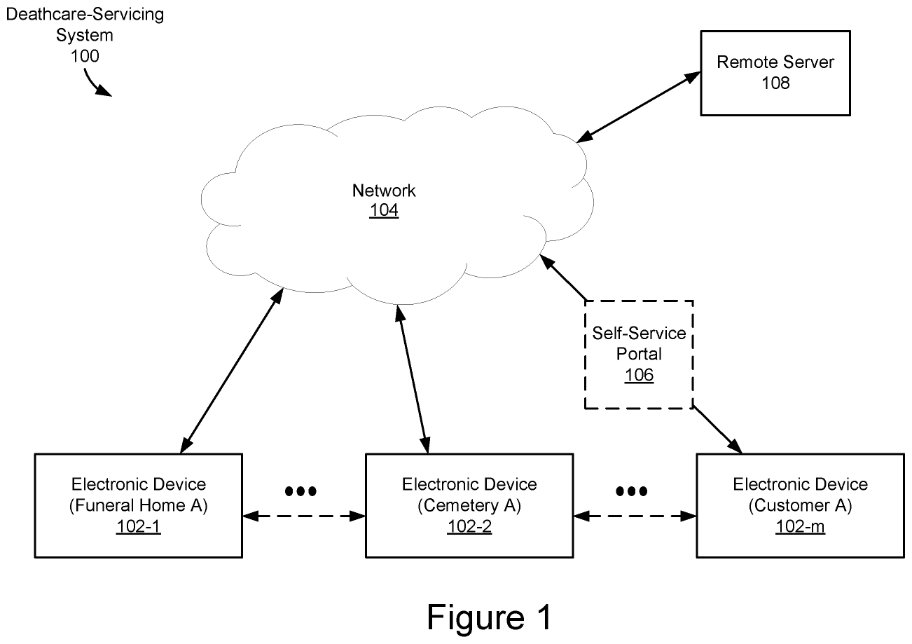

FIG. 1 is a block diagram illustrating a deathcare-servicing system 100, in accordance with some implementations. The deathcare-servicing system 100 includes one or more electronic devices 102 (e.g., electronic device 102-1 associated with a first deathcare provider Funeral Home A, electronic device 102-2 associated with a second deathcare provider Cemetery A, and/or electronic device 102-3 associated with Customer A), one or more remote servers (e.g., a remote data server, such as the remote server 108), and/or one or more data sources in electronic communication with the deathcare-servicing system 100 (e.g., databases located at, or otherwise in electronic communication with, the remote server 108). One or more networks (e.g., wired and/or wireless networks, such as the network 104) may be used to communicably couple the components of the deathcare-servicing system 100.

In some implementations, an electronic device 102 is associated with a particular deathcare provider (e.g., a funeral home, a cemetery, a crematory, and/or a combinational service, and/or a company associated with a plurality of different deathcare providers). In some implementations, when the electronic device 102 associated with the particular deathcare provider forms an electronic communication with the remote server 108, a particular set of data objects (e.g., one or more rows in a MongoDB database, one or more data structures from a JavaScript Object Notation data store) associated with the deathcare provider is accessed via the remote server 108 and provided to the electronic device 102 (e.g., via a data object stored within a network response). For example, the remote server 108 may include data associated with tens, hundreds, or perhaps thousands of individual deathcare providers (e.g., funeral homes, cemeteries, flower-service providers). In some implementations, the electronic device 102 is a personal computer, tablet computer, mobile phone, feature phone, smart phone, television, and/or another data server (e.g., a remote server associated with a self-service portal 106) and an electronic device 102-m shown in FIG. 1 represents between 1 and N electronic devices associated with and/or employed by a particular deathcare provider.

Electronic devices 102 may connect to each other wirelessly and/or through a wired connection (e.g., directly through an interface, such as an HDMI interface). In some implementations, electronic devices 102-1 and 102-m are the same type of device (e.g., electronic device 102-1 and electronic device 102-m are both speakers). Alternatively, electronic device 102-1 and electronic device 102-m include two or more distinct types of devices. Electronic devices 102 may connect to each other wirelessly and/or through a wired connection (e.g., directly through an interface, such as an HDMI interface).

In some implementations, electronic devices 102-1 and 102-m send and receive media-control information through network(s) 112. In some implementations, one or more electronic devices 102-m associated with customers of the one or more deathcare providers are able to send and receive media-control information through the network 104 using dedicated self-service portal 106 configured to form secure communication connections between a respective electronic device 102-m associated with a customer (e.g., Customer A).

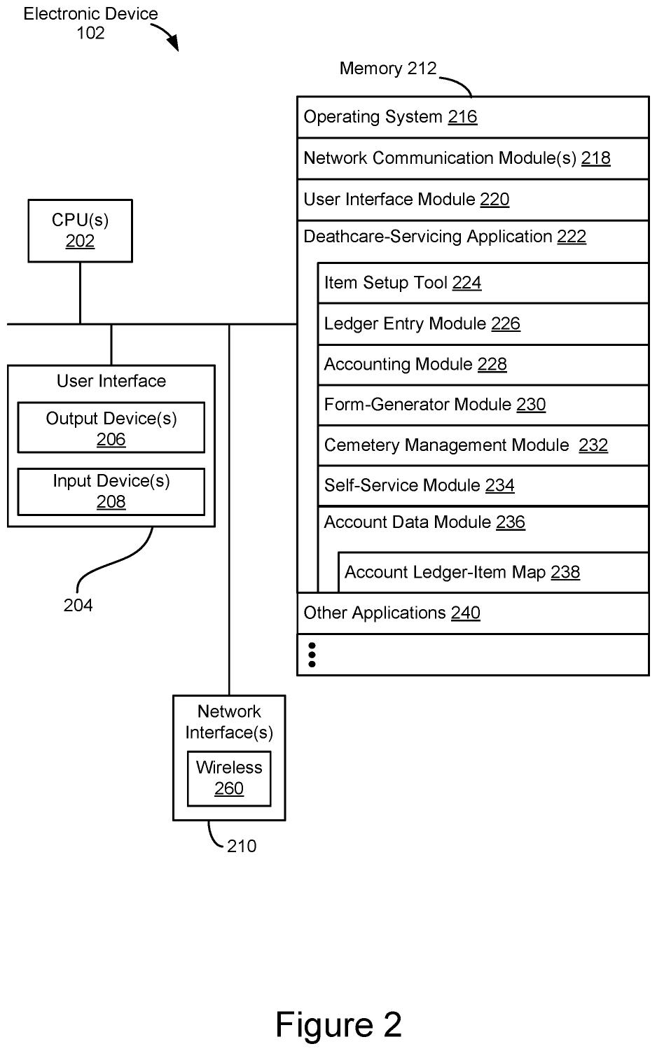

FIG. 2 is a block diagram illustrating an electronic device 102 (e.g., electronic device 102-1 and/or electronic device 102-m; FIG. 1) associated with a deathcare provider, in accordance with some implementations.

The electronic device 102 includes one or more central processing units (e.g., CPU(s), i.e., processors or cores) 202, one or more network (or other communications) interfaces 210, memory 212, and one or more communication busses for interconnecting these components. The one or more communication busses 214 optionally include circuitry (sometimes called a chipset) that interconnects and controls communications between system components. In some implementations, the network interfaces 210 include one or more wireless interfaces 260, which may be used to communicate with a remote server (e.g., the deathcare-provider server 108) to access database objects associated with respective deathcare-servicing items.

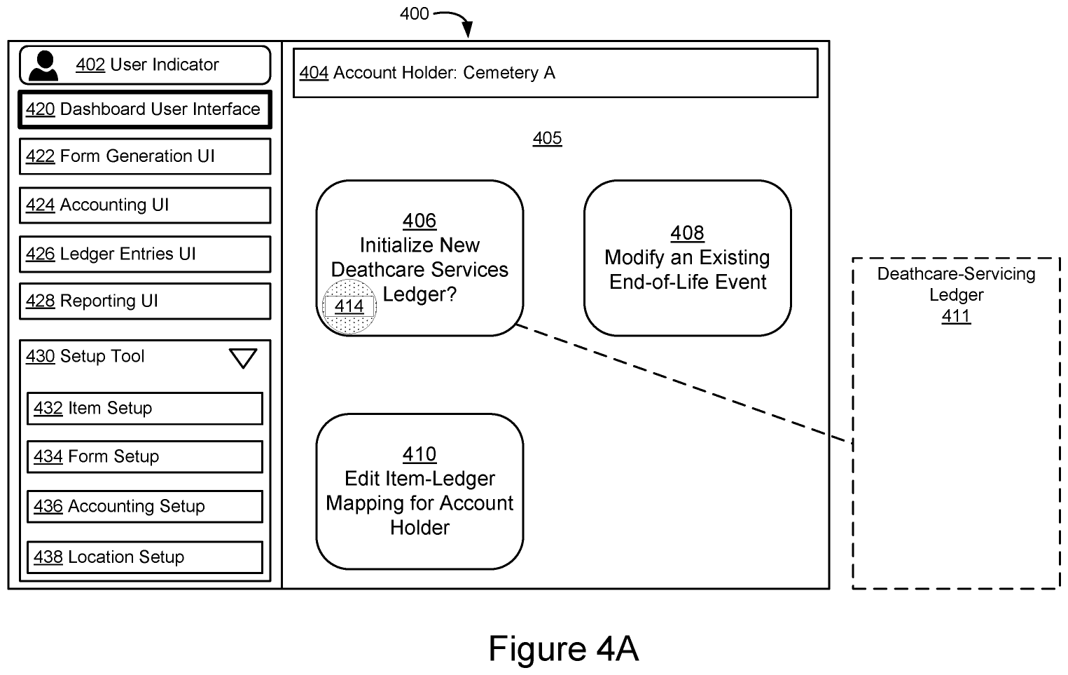

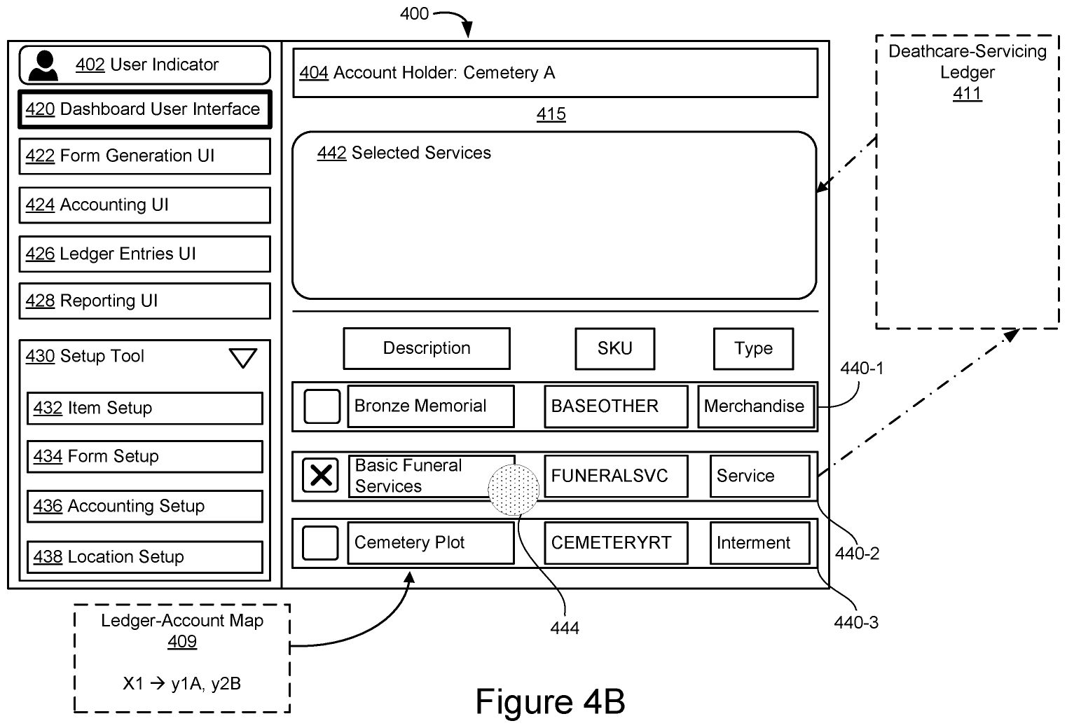

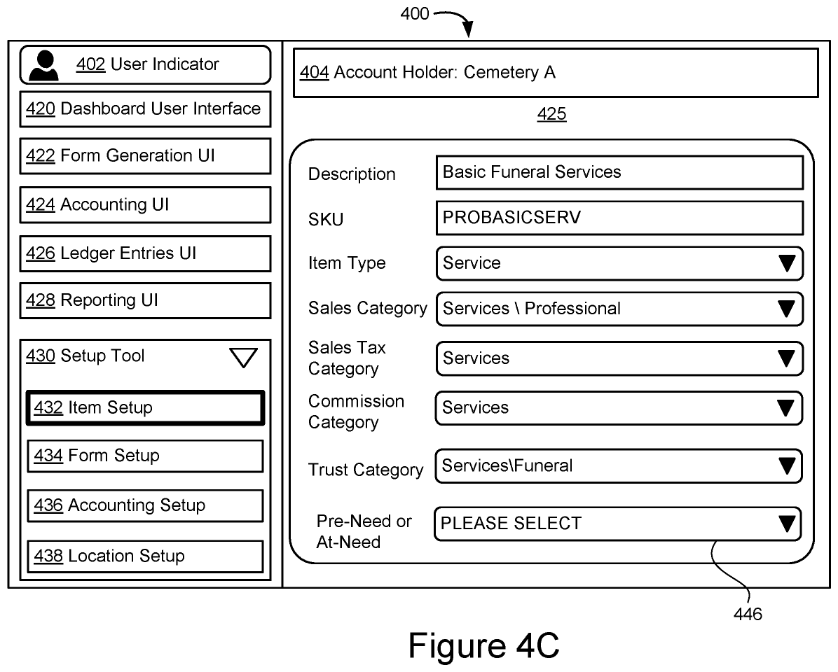

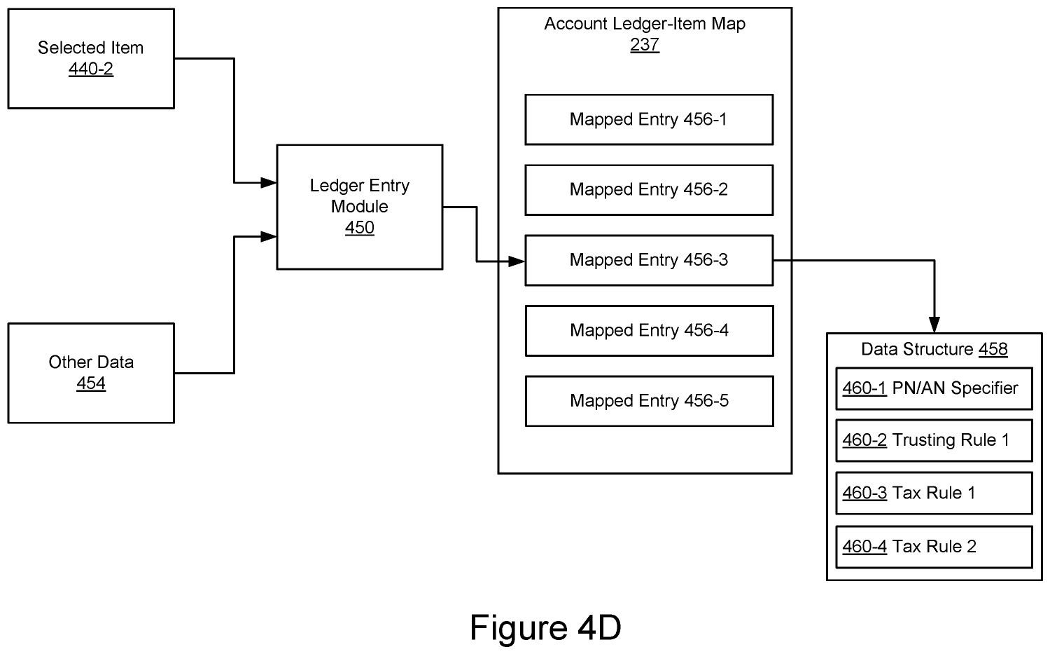

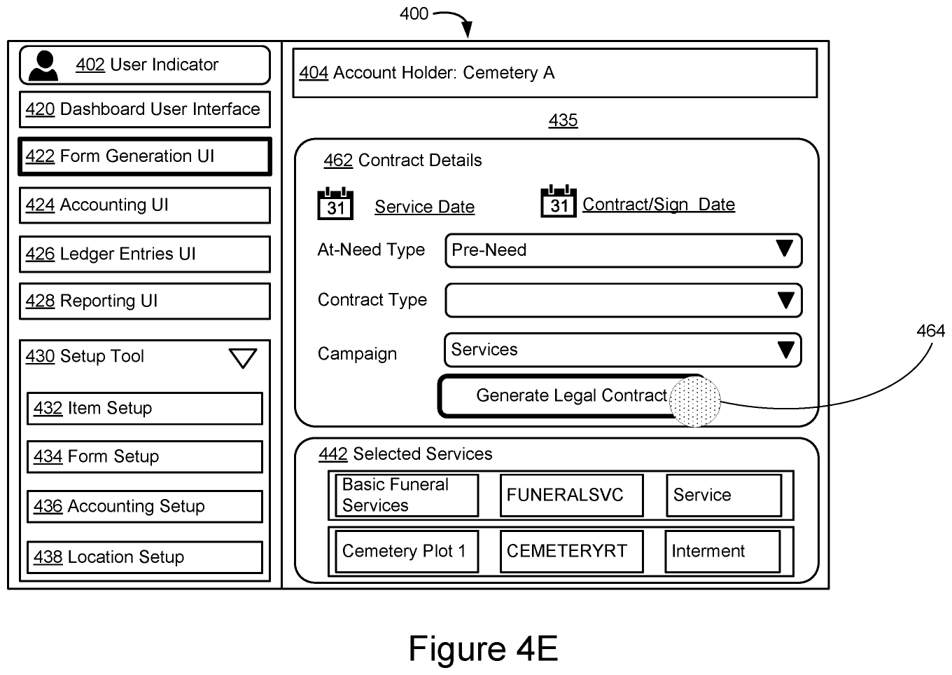

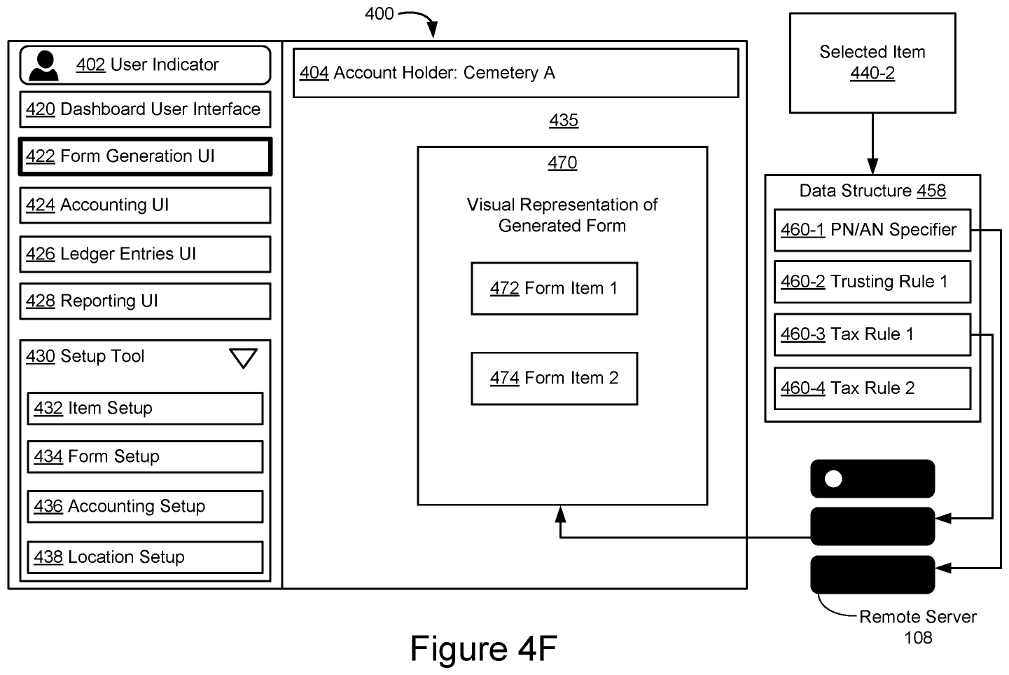

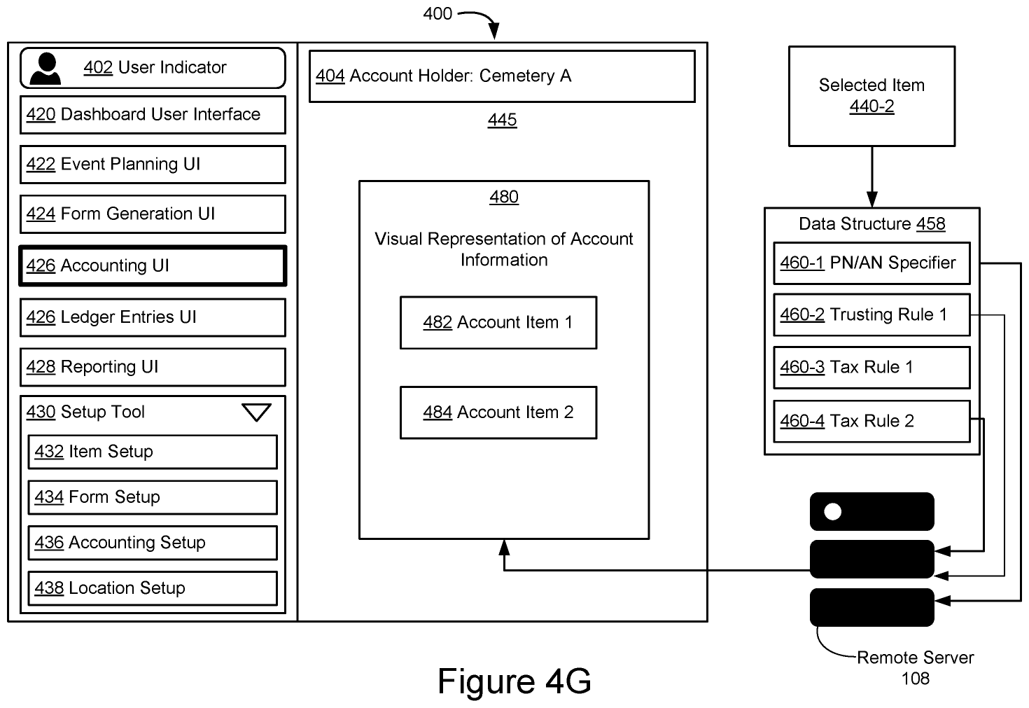

In some implementations, the electronic device 102 includes a user interface 204, including output device(s) 206 and/or input device(s) 208. In some implementations, the input devices 208 include a keyboard, a mouse, and/or a track pad. In some implementations, input devices 208 include a camera (e.g., a webcam) that captures images within a field of view adjacent to the electronic device 102. Alternatively, or in addition, in some implementations, the user interface 204 includes a display device that includes a touch-sensitive surface (e.g., when the display device is a touch-sensitive display). In some implementations, the output devices (e.g., output device(s) 206) include a speaker (e.g., speakerphone device) and/or an audio jack (or other physical output connection port) for connecting to speakers, earphones, headphones, or other external listening devices. Optionally, the electronic device 102 includes an audio input device (e.g., a microphone) to capture audio (e.g., speech from a user). In some implementations, one or more user interfaces of the electronic device 102 (e.g., a touch-sensitive display) can be used to present user interfaces of the deathcare-servicing application (e.g., user interfaces for facilitating various interactions with the deathcare-servicing application as described in more detail with respect to FIGS. 4A to 4G).

Optionally, the electronic device 102 includes a location-detection device 240, such as a global navigation satellite system (e.g., GPS (global positioning system), GLONASS, Galileo, BeiDou) or other geo-location receiver, and/or location-detection software for determining the location of the computer system 102 (e.g., a module for finding a position of the computer system 102 using trilateration of measured signal strengths for nearby devices).

Memory 212 includes high-speed random-access memory, such as DRAM, SRAM, DDR RAM, or other random-access solid-state memory devices, and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some implementations, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the computer system 102 to other computing devices;
a user interface module 220 that receives commands and/or inputs from a user via the user interface 204 (e.g., from the input devices 208) and provides outputs for, e.g., display on the user interface 204 (e.g., the output devices 206);
a deathcare-servicing application 222 for generating deathcare-servicing ledgers and associated scheduling, forms, and/or other aspects for facilitating deathcare services and/or merchandise corresponding to an end-of-life related event, the deathcare-servicing application 222 including, but not limited to, one or more of:
   An item setup tool 224 for mapping respective items associated with deathcare services or merchandise available by a particular deathcare provider to general ledger entries associated with the particular deathcare services and/or merchandise;
   A ledger entry module 226 for storing a set of ledger entries associated with an end-of-life related event based on respective items associated with available deathcare services and/or merchandise selected by a user of the deathcare-servicing application;
   An accounting module 228 for presenting a first set of user interfaces including a first set of data items based on the set of ledger entries associated with respective end-of-life related events;
   A form-generator module 230 for presenting a set of user interfaces for generating and otherwise interacting with a set of predefined forms associated with the end-of-life related event based on data objects corresponding to the identified general ledger entries for the end-of-life related event;
   A cemetery management module 232 for associating a set of interment rights corresponding to cemetery sites of a particular cemetery location to items for selection as part of coordinating an end-of-life event;
   A self-service module 234 for providing secure access to at least a portion of the deathcare-servicing application 222 to a customer of a particular deathcare provider;
   An account data module 236 for storing data associated with a particular account (e.g., an account associated with one or more corresponding deathcare providers), optionally including:
      An account ledger-item map 238 including a set of relationships between selectable items associated with deathcare services and/or merchandise that are available to be provided to a user of the deathcare-servicing application 222 and a corresponding set of ledger entries configured to be identified based on selections of the selectable items by a user of the deathcare-servicing application; and
other applications 240, such as applications for word processing, calendaring, mapping, weather, stocks, time-keeping, virtual digital assistant, presenting, number crunching (spreadsheets), drawing, instant messaging, email, telephone, video conferencing, photo management, video management, etc.

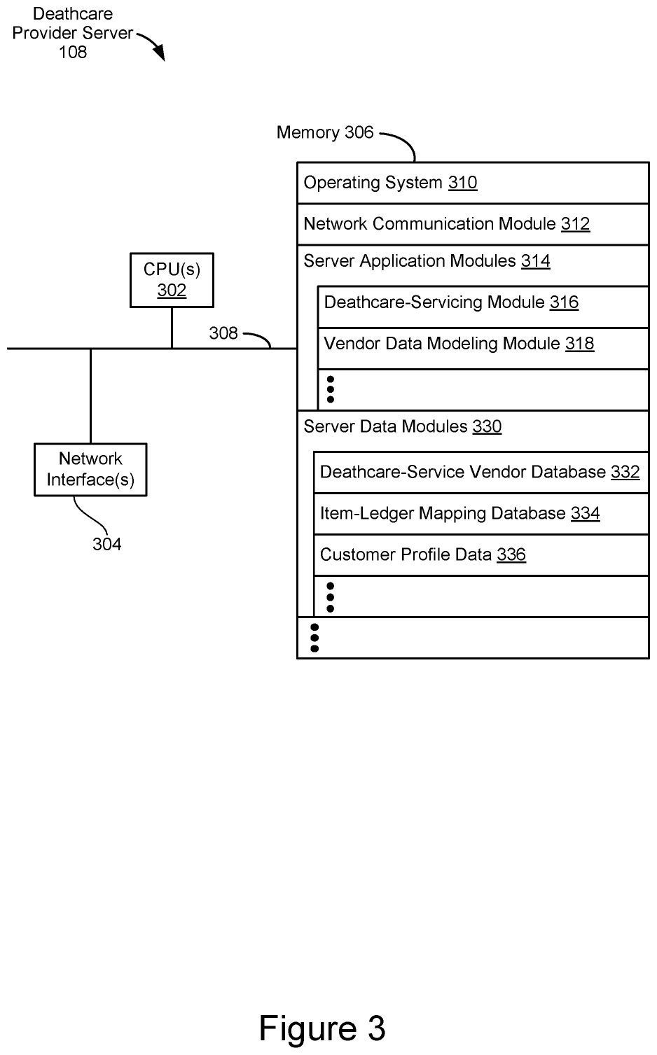

FIG. 3 is a block diagram illustrating the remote server 108 of the deathcare-servicing system 100, in accordance with some implementations. The remote server 108 typically includes one or more central processing units/cores (CPUs) 302, one or more network interfaces 304, memory 306, and one or more communication busses 308 for interconnecting these components.

Memory 306 includes high-speed random-access memory, such as DRAM, SRAM, DDR RAM, or other random access solid-state memory devices, and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some implementations, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting other computing devices via one or more network interfaces 304 (wired or wireless);
one or more server application modules 314 for performing various functions with respect to providing and managing a content service, the server application modules 314 including, but not limited to, one or more of:
   a deathcare-servicing module 316 for facilitating interactions between respective deathcare providers and the deathcare-servicing application while it is being caused to be executed at an electronic device 102-1; and
   a vendor data modeling module 318 for providing user interfaces associated with particular deathcare providers for analyzing and/or otherwise reviewing data associated with end-of-life events stored in the server data modules 330.
one or more server data module(s) 330 for handling the storage of and/or access to data relating to the provision of secure computer sessions; in some implementations, the one or more server data module(s) 330 include:
   A deathcare provider vendor database 332 for storing data related to items available to be provided by particular deathcare providers, including deathcare providers having third-party relationships with the particular deathcare providers accessing the deathcare provider server (e.g., a flower vendor having a contractual relationship to provide merchandise and/or services to a deathcare provider having an account associated with the deathcare-servicing module 316);
   An item-ledger mapping database 334 for storing data for mapping a set of deathcare-servicing items that a deathcare provider is capable of providing for an end-of-life event to corresponding ledger entries storing data about a particular accounting of the providing the respective deathcare-servicing items; and
   Customer profile data 336 includes information about a customer that configures operation of a server 108, electronic device 102, deathcare servicing application 222 and/or server application module 314 to customize, configure, evaluate and/or preselect deathcare services offered and/or presented to a customer.

In some implementations, the remote server 108 includes web or Hypertext Transfer Protocol servers, File Transfer Protocol servers, as well as webpages and applications implemented using Common Gateway Interface script, PHP Hyper-text Preprocessor, Active Server Pages, Hyper Text Markup Language (HTML), Extensible Markup Language (XML), Java, JavaScript, Asynchronous JavaScript, and XML, XHP, Javelin, Wireless Universal Resource File, and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise rearranged in various implementations. In some implementations, memory 212 and 306 optionally store a subset or superset of the respective modules and data structures identified above. Furthermore, memory 212 and 306 optionally store additional modules and data structures not described above.

Although FIG. 3 illustrates the remote server 108 in accordance with some implementations, FIG. 3 is intended more as a functional description of the various features that may be present in one or more remote servers than as a structural schematic of the implementations described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the remote server 108, and how features are allocated among them, will vary from one implementation to another and, optionally, depends in part on the amount of data traffic that the server system handles during peak usage periods as well as during average usage periods.

FIG. 4A-4G are sequence diagrams illustrating user interfaces and operations of a deathcare-servicing application 400, in accordance with some implementations. The deathcare-servicing application 400 is being presented at a display of the electronic device 102-2 (which is associated with a particular deathcare provider, Cemetery A).

FIG. 4A shows a user interface 405 (e.g., a first user interface, a dashboard user interface), which is configured to be presented when a user (e.g., an account holder, such as an agent of Cemetery A) logs into the deathcare-servicing application 400. In some implementations, when the user logs into the deathcare-servicing application 400, an account identity indicator 402 associated with the user (e.g., account holder) is presented (e.g., automatically, without further user input). In some implementations, the user interface 405 includes a universal display component (e.g., a tabbed sidebar) that includes one or more user interface elements that persist within other user interfaces of the deathcare-servicing application 400. In some implementations, the universal display component includes selectable user interface elements corresponding to distinct user interfaces of the deathcare-servicing application 400 (some of which will be described in more detail herein), including one or more of (i) a dashboard user interface selection element 420; (ii) a form-generating user interface selection element 422; (iii) an accounting user interface selection element 424; (iv) a ledger-entry-viewing user interface selection element 426; and/or (v) a reporting user interface selection element 428. In accordance with some implementations, two or more of the user interfaces configured to be presented based on selection of respective user interface elements include data associated with a same set of ledger entries provided (e.g., stored) at a deathcare-servicing ledger associated with an end-of-life event, as will be discussed in more detail below.

The universal display component may include one or more user interface elements for controlling setup of respective software operations associated with the user interface elements corresponding the distinct user interfaces of the deathcare-servicing application 400 (e.g., an item setup selection element 432, a form setup selection element 434, an accounting setup selection element 436, and/or a location setup selection element 438). In accordance with some implementations, setup tools of the deathcare-servicing application 400 can be optionally implemented to modify default configurations for one or more of the configurations made available via the respective setup tools.

In some implementations, one or more elements of the dashboard user interface are automatically populated based on the account identity indicator of the user recognized by the deathcare-servicing application. For example, an information user interface element 404 includes an indication that the user is associated with a particular deathcare provider (e.g., “Cemetery A”).

In accordance with some implementations, the user interface 405 includes a set of user interface elements configured for performing common operations of the deathcare-servicing application 400. For example, selection of the user interface element 406 may cause instantiation of a deathcare-servicing ledger for a new end-of-life event. Selection of the user interface element 408 may allow a user to modify an existing deathcare-servicing ledger (e.g., adding, modifying, and/or removing items from the deathcare-servicing ledger). And selection of the user interface element 410 may cause an item setup user interface to be presented by deathcare-servicing application 400, where the item setup user interface allows the user to modify a mapping between particular deathcare-servicing items and sets of the ledger entries that the deathcare-servicing items correspond to. In FIG. 4A, the user is performing a user input 414 directed to the user interface element 406, which causes a new deathcare-servicing ledger to be created by the deathcare-servicing application 400.

FIG. 4B shows an item selection user interface 415 being presented by the deathcare-servicing application 400. The item selection user interface 415 includes a list of items (e.g., items 440-1, 440-2, and 440-3), where each of the items in the list of items are related to particular deathcare services and/or merchandise related to an end-of-life event. In accordance with some implementations, each of the items shown in the list of items corresponds to at least one respective ledger entry of a set of ledger entries for each respective item. The item selection user interface 415 further includes an item-listing user interface element 442 showing which deathcare services and/or merchandise the user has selected for the particular end-of-life event. In accordance with some implementations, the contents of the item-listing user interface element correspond to the respective ledger entries stored at the deathcare-servicing ledger 411 associated with the end-of-life event. For example, the deathcare-servicing ledger 411 may include a particular ledger entry that is one of three possible ledger entries associated with a particular deathcare-servicing item. And the deathcare-servicing application 400 may present the particular deathcare-servicing item with which the ledger entry is associated within the item-listing user interface element 442. In this way, the ledger entries stored in the deathcare-servicing ledger 411 can be transformed into the visual representation that the user is familiar with for each respective user interface that includes relevant information about one or more ledger entries of the deathcare-servicing ledger 411.

In accordance with some implementations, the items displayed within the item selection user interface 415 can be associated with different kinds of goods and services. In some implementations, when the user logs in, the deathcare-servicing application sends a request to a back end (e.g., the remote server 108) for the list of items based on the identity of the account holder (e.g., the particular deathcare provider using deathcare-servicing application 400). In some implementations, the deathcare-servicing application determines that the identified account holder has an associated ledger-account map 409, where the ledger-account map 409 includes a set of deathcare-servicing items and the respective sets of ledger entries to which each respective deathcare-servicing item of the set of deathcare-servicing items correspond. In some implementations, only one deathcare-servicing item is presented for each item in the ledger-account map displayed at the user interface 415, even if a plurality of different ledger entries is associated with the respective deathcare-servicing item.

In accordance with some implementations, the respective items in the list of items can be associated with different deathcare-servicing types. For example, in accordance with some implementations, the item 440-1 corresponds to a physical item of merchandise (e.g., “Bronze Memorial”) configured to associate with (e.g., engraved with) information related to the end-of-life event. In some implementations, all of the physical items of merchandise that surface within the item-selection user interface are available by the particular user associated with the electronic device 102-2 (e.g., directly and/or through a third-party having a particular relationship with the deathcare provider). In accordance with some implementations, the item 440-2 corresponds to a particular set of deathcare services associated with the end-of-life event (e.g., “Basic Funeral Services”), where the set of deathcare services includes (i) a request for a particular time frame, and (ii) a required participant to be available at the particular time frame. In accordance with some implementations, the item 440-3 corresponds to an available interment right at a physical location associated with the deathcare provider (e.g., “Cemetery Plot”), where the available interment right is based on developed cemetery plots owned by the deathcare provider.

The user is performing a user input 444 directed to the deathcare-servicing item 440-2, corresponding to a set of deathcare-servicing parameters (e.g., time, date, required staff) for basic funeral services (e.g., a funeral service, a burial). In some implementations, when the user selects the particular deathcare-servicing item 440-2, the deathcare-servicing application 400 identifies a set of ledger entries corresponding to the particular deathcare-servicing item, wherein the particular ledger entry of the set of ledger entries is identified based on other data about the end-of-life event that has been received by the deathcare-servicing application 400.

In some implementations, the other data about the end-of-life event that is used to identify the particular ledger entry based on the selected deathcare-servicing item may include customer profile data acquired about the customer and/or the end-of-life event before the item selection user interface is presented within the user interface 415. In some implementations, the set of deathcare-servicing items that are presented within the user interface 415 is determined, at least in part, based on some portion of the other data received by deathcare-servicing application 400. For example, the deathcare-servicing application 400 may include one or more templated sets of deathcare-servicing items that are configured to be presented together within the user interface 415 based on an indication that a customer is seeking a particular subset of services that are available by the deathcare provider (e.g., cremation and associated services). As one example, the customer profile data may include an indication of a type of deathcare service that the customer is requesting, such as crematory services, or a burial. Based on the customer profile data indicating that the user is specifically selecting crematory services, a particular templated item set stored within the deathcare-servicing application 400 for the particular deathcare-servicing provider may be selected to be presented to the user within the item selection user interface 415. In this way, the systems, devices, and methods described herein provide for efficient and intuitive operations of the deathcare servicing application (e.g., reducing the computation time of processors facilitating operations of the deathcare-servicing application) and/or a more efficient man-machine interface for surfacing deathcare-servicing items that are most relevant to a customer based on information that they have previously provided in a different context. In some implementations, particular sets of deathcare-servicing items may be presented to users within the item selection user interface 415 based on other factors in addition, or alternative to, the type of deathcare services that the customer is interested in selecting.

In some implementations, different price tiers of a same type of deathcare services may be available (e.g., standard, premium, value, etc.). In accordance with such implementations, particular information that the user provides to the deathcare-servicing application 400 may be used to determine which of a set of price tiers the customer is most likely to select deathcare services. For example, a customer may provide an intended burial location (e.g., a specialized burial location within a cemetery that is not a traditional headstone placement) indicating that the customer is interested in premium deathcare services. Based on the provided information, the deathcare-servicing application may cause deathcare-servicing items to be presented (i) of a specific type, and (ii) of one or more price tiers of deathcare services.

Based on the particular deathcare-servicing item selected, and the other data received by the deathcare-servicing application 400 (e.g., customer profile data, first-call audio data received from a coroner), a particular ledger entry is identified based on the user's selection of the deathcare-servicing item. Alternatively, as discussed below with respect to FIG. 4C, additional user interfaces may be presented to the user (e.g., the item configuration user interface 425) in order to determine which particular ledger entry should be added to the deathcare-servicing ledger 411 based on the user's selection of the particular deathcare-servicing item 440-2.

FIG. 4C shows an item configuration user interface 425 associated with the first item that the user selected in FIG. 4B. In some implementations, after the user selects a deathcare-servicing item, the deathcare-servicing application 400 determines if a sufficient amount of other data has been received about the end-of-life event to identify a particular ledger from a set of ledger entries corresponding to the particular deathcare-servicing item. In some implementations, one or more fields may be auto-populated within the item configuration user interface 425 based on other data received by the deathcare-servicing application 400, and/or default parameters that are inferred based on a lack of data about a particular ledger-identification parameter. In some implementations, the deathcare-servicing application 400 forgoes presenting the item configuration user interface 425 in accordance with a determination that the other data received by the deathcare-servicing application 400 is sufficient for identifying the particular ledger entry associated with the selected deathcare-servicing item. In some implementations, the particular fields within the item configuration user interface 425 may be determined based on the other data that is required for determining a particular ledger entry based on the deathcare-servicing item that was selected by the user. For example, the field 446 (e.g., corresponding to a selection of “pre-need” or “at-need”) may be presented based on determining that no other data has been provided about the end-of-life event indicating whether the end-of-life event to which the deathcare-servicing ledger 411 corresponds has already occurred, or if the deathcare-servicing item is being purchased for a future unspecified date.

FIG. 4D illustrates an example data flow corresponding to a selection of a respective item (e.g., the item 440-2) within the deathcare-servicing application 400 (e.g., based on the user input 444 within the item selection user interface 415 shown in FIG. 4B). For example, in accordance with some implementations, when the user selects an item from within the item selection user interface 415 (e.g., the selected item 440-2), the deathcare-servicing application 400 determines whether other data 454 received by the deathcare-servicing application 400 can be used to identify a corresponding mapped ledger entry (e.g., mapped entry 456-3). That is, the selected item 440-2 may correspond to one of a plurality of different mapped ledger entries (e.g., mapped entry 456-1, mapped entry 456-2, mapped entry 456-3, mapped entry 456-4, and/or mapped entry 456-5), which may each correspond to separate data structures (e.g., a data structure 458) that include particular ledger entry data for representing aspects of the ledger entry in other parts of the deathcare-servicing application 400 (e.g., a pre-need/at-need specifier 460-1, a trusting rule 460-2, a tax rule 460-3, and/or a tax rule 460-4). In some implementations the mapped entries that are stored in the account ledger-item map 237 are configured by a user of the deathcare-servicing application 400. In some implementations, one or more associations within the account ledger-item map 237 are generated based on default ledger configuration rules (e.g., every entry of a particular type of deathcare-servicing item becomes associated with a first mapped entry for pre-need, and a second mapped entry for at-need, etc.).

In accordance with some implementations, when the deathcare-servicing application 400 account ledger-item map 238 has been created by the deathcare-servicing provider that is accessing the deathcare-servicing application, the deathcare-servicing application 400 may forego providing the selected item 440-2 and/or the other data 454 to the ledger entry module 450 (thus causing no ledger entry to be selected corresponding to the selected deathcare-servicing item). In such implementations, information associated with the selected deathcare-servicing items may be used to perform subsequent operations such as contract generation and/or accounting functions. In some implementations, one or more user interfaces of the deathcare-servicing application 400 are configured to operate differently and/or include different user interface elements based on whether the user of the deathcare-servicing application 400 is associated with a deathcare-servicing provider corresponding to an account ledger-item map. For example, the form-generation user interface 435 shown in FIG. 4E may include additional options for manually providing information that would have otherwise been obtained based on the particular ledger entries identified based on the selection of the deathcare-servicing items (e.g., a selector user interface for specifying whether the form being generated is for pre-need or at-need services). In some implementations where no account item-ledger map has been configured, the deathcare-servicing application may include a default set of deathcare-servicing items associated with generic and/or commonly selected deathcare-servicing items (e.g., miscellaneous burial services, miscellaneous cremation services, standard funeral services), such that a new user can use the deathcare-servicing application 400 to coordinate services related to an end-of-life event without having previously configured the deathcare-servicing application 400 with any provider-specific information. In accordance with some implementations, a deathcare provider may partially configure an account item-ledger map for their particular needs while using default configurations for other services made available by the deathcare-servicing application 400.

When the user selects the item 440-2, various interactions can take place at the deathcare-servicing application 400 based on whether the other data 454 is sufficient for the ledger entry module 450 to determine which mapped entry the selection corresponds to. In accordance with a first determination that no additional data is required based on the other data 454 available about the end-of-life event, the deathcare-servicing application 400 forgoes presenting the item configuration user interface 425 shown in FIG. 4C. In accordance with a second determination that additional data is required based on the other data 454 that has already been received about the end-of-life event, a particular item configuration user interface may be presented to the user based on the other data that is still necessary to determine a particular ledger entry (e.g., mapped entry 456-3) that the selection of the deathcare-servicing item corresponds to.

FIG. 4E shows an example form-generation user interface 435, which includes a first user interface element 462 for entering additional details about the contract, as well the item-listing user interface element 442 indicating the items that the user has selected (which may be the item-listing user interface element 442 shown in FIG. 4B). The items shown in the item-listing user interface element 442 may be determined based on the ledger entries in the deathcare-servicing ledger 411, as depicted in previous Figures of the sequence shown by FIGS. 4A to 4G. The user is performing a user input 464 directed to a selectable user interface element within the first user interface element 462 for generating a legally compliant digital form based on information in deathcare-servicing ledger 411.

FIG. 4F shows a preview of the digital form generated as described in FIG. 4E (e.g., visual representation 470). As shown by the block diagram to the right of the deathcare-servicing application 400, when the user chooses to generate a legally compliant digital form, the selected item 440-2 (e.g., basic funeral services) is mapped to a data structure 458 (which may be a unique data structure and/or a template-based data structure having a predefined set of data values) based on the ledger entry (mapped entry 456-3) that was identified (as shown in FIG. 4D) as corresponding to the particular selection of the selected item 440-2 (e.g., based on the other data that the deathcare-servicing application 400 has received about the end-of-life event). In some implementations, a first set of data objects is identified (e.g., from the remote server 108) based on the information in data structure 458 corresponding to the mapped entry 456-3, and the first set of data objects is used to generate and present the visual representation 470. For example, a form item 472 may include an amount of a payment for the particular deathcare service or merchandise based on information in the mapped entry 456-3 about whether the particular deathcare item is for pre-need or at-need services. In some implementations, one or more aspects of the legally compliant digital form is based on the other data 454 that was received by the deathcare-servicing application 400 about the end-of-life event that is not related to the mapped entry 456-3. For example, some of the other data 454 may indicate whether the end-of-life event occurred within a particular area (e.g., a state, city, or other municipality) having required disclosures for contracts for particular deathcare services, and the visual representation 470 may include one or more of the other information items based on the area where the deathcare services are being purchased or fulfilled (e.g., a form item 474, which may correspond to a required disclosure for purchasing deathcare services or merchandise in the state of New Jersey).

In some implementations, after the user of the deathcare-servicing application 400 has caused a form to be generated based on the selected ledger entries, the deathcare-servicing application 400 may cause the information from the particular ledger entries to be placed in an intermediate (e.g., non-finalized) state that requires further action in order for the ledger entries to be added to the deathcare-servicing ledger. For example, the deathcare-servicing application 400 may include an internal queue for managing deathcare-servicing items that have been selected by a respective user (e.g., a funeral director working with a customer, or a customer themselves) and have been subject to a self-generated form of the deathcare provider. In some implementations, the deathcare-servicing application 400 does not add the particular ledger entries to the deathcare-servicing ledger associated with the end-of-life event until after the particular ledger entries have been approved and/or modified (e.g., by a different user than the user that selected the deathcare-servicing items). In some implementations, the deathcare-servicing application 400 is configured to, in accordance with receiving an indication that the particular ledger entries have been approved and added to the deathcare-servicing ledger, automatically (without additional user input) send the self-generated form to the subject parties (e.g., via a digital signing application).

In some implementations, the user that selected the deathcare-servicing items (e.g., a funeral home director) has a first set of permissions (e.g., including a permission for selecting deathcare-servicing items to add to the ledger). And another user (e.g., an accountant of the deathcare-servicing provider) having a second set of permissions, distinct from the first set of permissions, may be able to modify the data (e.g., commissioning parameters) of the particular ledger entries that were identified based on the selections of the deathcare-servicing items. In some embodiments, the user having the permissions to modify the data of the particular ledger entries may not have the second set of permissions to modify the deathcare-servicing items that are associated with the transaction. In other words, the second set of permissions may be limited to, for example, accounting parameters associated with the selected services for the end-of-life event, such that the other user having the second set of permissions is able to modify particular pricing and/or accounting parameters, but may not add or remove deathcare-servicing items from the set of deathcare-servicing items that were selected by the user having the first set of permissions.

FIG. 4G shows the user selecting a different user interface element of the deathcare-servicing application 400 to cause an accounting user interface 445 to be presented by the deathcare-servicing application 400. In accordance with some implementations, the accounting user interface 445 includes a visual representation 480 of a particular set of account information (e.g., a breakdown of revenue based on the deathcare-servicing ledger 411) that is based on information stored in the data structure 458 of the mapped ledger entry 456-3 associated with the particular deathcare-servicing item that the user selected in FIG. 4B (e.g., the deathcare-servicing item 440-2). For example, based on an amount (e.g., a purchase price) for the deathcare-servicing item 440-2, along with the trusting rule 460-2 of the data structure 458 corresponding to the mapped ledger entry 456-3, a first amount may be presented as an account item 482 within the visual representation 480, and another account item 484 presented as part of the visual representation 480 may be based on one or both of the tax rules 460-3 and 460-4 stored in the data structure 458 corresponding to the mapped ledger entry 456-3. In accordance with some implementations, different subsets of the data structure 458 corresponding to the ledger entry 456-3 are used to cause presentation of the visual representation 480 that are used to cause presentation of the visual representation 470 shown in FIG. 4F.

In some implementations, the accounting user interface 445 is configured to display some or all of the same information (e.g., based on the data from the particular ledger entries corresponding to the selected deathcare-servicing items) in different visual formats and/or with different analytical parameters, which may be based on the type of user that is accessing the application. For example, the user may be able to toggle, within the user interface 445, between different views corresponding to the same deathcare-servicing ledger. For example, a first view may present an accounting user interface indicating an amount of money that will be applied to one or more ledger accounts based on the particular ledger entries. And, in accordance with a user selecting a user input to toggle the view shown within the user interface 445 to show an unformatted view of the data (e.g., raw data) of each of the ledger entries in the deathcare-servicing ledger.

### EXAMPLE EMBODIMENTS

Various embodiments of the example systems, devices, and methods described herein will now be discussed in more detail below. One of skill in the art will understand that the example embodiments described below are not the only embodiments enabled by this disclosure, and that various alternative permutations of the described methods, systems, and devices may be suitable for performing the one or more sets of operations described herein.

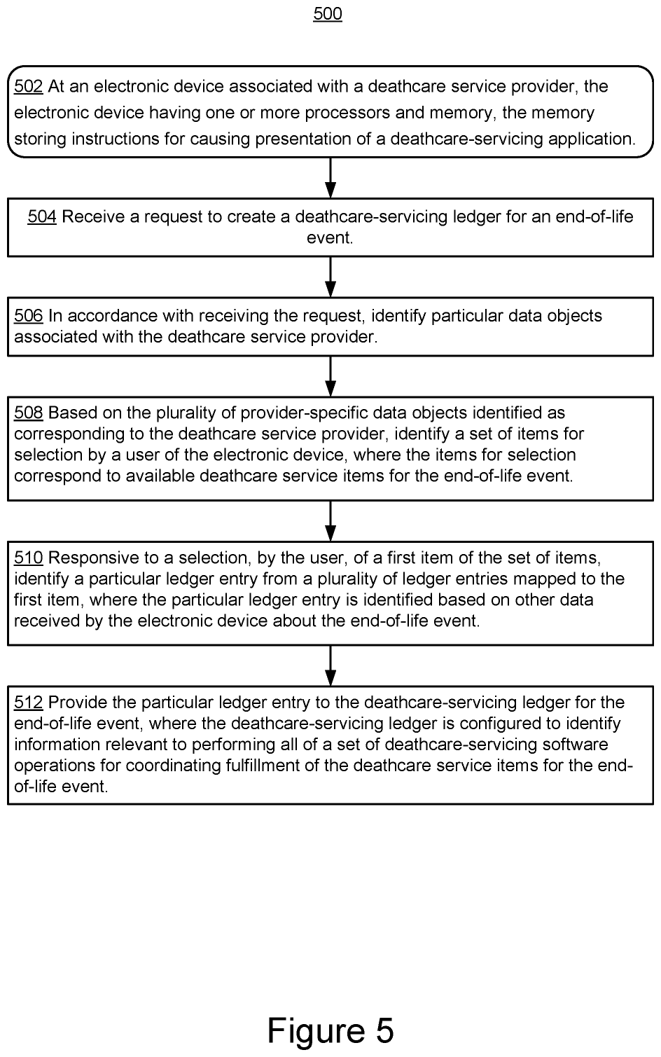

FIG. 5 is a flow diagram illustrating a method 500 performed by the deathcare-servicing application 400, in accordance with some implementations. For ease of description, the following embodiments are described in terms of the methods, systems, and devices described above with respect to FIGS. 1 to 4G. The one or more operations of the method 500 may be implemented, for example, by the electronic device 102-2 associated with the particular deathcare provider Cemetery A, alone or in conjunction with the remote server 108. In some implementations, one or more operations may be implemented apart from other operations, and by one or more different processors or devices. Further, for explanatory purposes, to the extent that the operations of the method 500 are described as occurring in serial, or linearly, in some implementations, multiple operations of the method 500 may occur in parallel (e.g., operations 510 and 512 may occur in parallel). The operations of the method 500 need not be performed in the order shown, and one or more operations of the method 500 need not be performed at all, in some implementations.

(A1) In the depicted example, the operations of the method 500 occur at (502) the electronic device 102-2 associated with Cemetery A. The electronic device 102-2 includes the one or more processors 202 and the memory 212. The memory 212 stores instructions (e.g., at the deathcare-servicing application 222, which may include instructions for performing some or all of the operations described with respect to FIGS. 4A to 4G) for causing presentation of a deathcare-servicing application. For example, one or more output devices 206 of the electronic device 102-2, including an integrated display, can present (e.g., display) the user interfaces described with respect to FIGS. 4A to 4G (e.g., the user interface 405, the user interface 415, etc.).

The electronic device 102-2 receives (504) a request to create a deathcare-servicing ledger for an end-of-life event. For example, a director of a cemetery site may provide the user input 414 directed to the user interface element 406 to create a deathcare-servicing ledger, based on the request for deathcare services or merchandise related to an individual's passing. In accordance with some implementations, the request is performed automatically by the deathcare-servicing system 100 based on communication received from a third party (e.g., first-call data received from a coroner). For example, the deathcare-servicing system 100 may include one or more electronic devices 102 associated with coroners and/or medical professionals responsible for reporting end-of-life events, and a respective deathcare-servicing ledger may be automatically created in accordance with an indication provided by a respective electronic device 102 that has access to create a deathcare-servicing ledger 411 on behalf of the deathcare provider associated with a particular ledger account.

In accordance with receiving the request, the deathcare-servicing application 400 identifies (506) particular data objects associated with the deathcare provider. For example, the remote server 108 may be configured to store collections of data objects (e.g., databases, files and/or directories of structured data) associated with a plurality of deathcare providers. And the deathcare-servicing application may identify, using a search query, a subject of particular data objects that are associated with the deathcare provider Cemetery A.

Based on the plurality of provider-specific data objects identified as corresponding to the deathcare provider, the deathcare-servicing application identifies (508) a set of items for selection by a user of the electronic device 102-2, wherein the set of items correspond to available deathcare service and/or merchandise items for the related end-of-life event. For example, a respective item of the set of items may include a respective available deathcare service item corresponding to basic services for a funeral (e.g., a service, a burial, etc.).

Responsive to a selection, by the user, of a first item of the set of items, the deathcare-servicing application 400 identifies (510) a particular ledger entry from a plurality of ledger entries mapped to the first item, where the particular ledger entry is identified based on other data (e.g., account profile data) received by the electronic device about the end-of-life event. For example, other data 454 may be received as part of the process of engaging the client about the end-of-life event (e.g., via a questionnaire that the client receives upon initiation of the request for deathcare services).

In accordance with some implementations, the other data may include one or more of the following: first call data from a coroner; obituary information; account profile data; one or more credit profiles associated with the customer; medical data; cost-estimate selections, and the like.

And the deathcare-servicing application 400 provides (512) the particular ledger entry to the deathcare-servicing ledger for the end-of-life event, where the deathcare-servicing ledger is configured to identify information relevant to performing all of a set of deathcare-servicing software operations for coordinating fulfillment of the deathcare service and/or merchandise related to the end-of-life event. For example, the particular ledger entry (e.g., the mapped entry 456-3) may include and/or correspond to a data structure 458 that includes information for causing presentation of different user interfaces related to the particular ledger entry (e.g., the form-generation user interface 435, the accounting user interface 445).

(A2) In some implementations of A1, the other data received via the electronic device about the end-of-life event includes an indication whether the end-of-life event has occurred or is yet to occur (e.g., a pre-need/at-need specifier 460-1). And in accordance with a first indication that the end-of-life event has not yet occurred, the particular ledger entry is identified as a pre-need ledger entry corresponding to a respective end-of-life event that has yet to occur, and identification of a different ledger entry mapped to the first item, identified as an at-need ledger entry, is forgone.

(A3) In some implementations of A2, the deathcare-servicing system 100 receives audio data corresponding to a first call, from a third-party such as a coroner, nursing home, or hospital, related to another end-of-life event. And the deathcare-servicing system 100 provides (e.g., to the deathcare-servicing application 400), based on the received audio data, a second indication that the other end-of-life event has already occurred to a different deathcare-servicing ledger associated with the other end-of-life event. In some implementations, one or more machine-learning models are used to translate audio data into data for identifying deathcare-servicing items to add to a deathcare-servicing ledger based on the content of the audio data.

(A4) In some implementations of any one of A1 to A3, after the particular ledger entry has been provided to the deathcare-servicing ledger, a first request and a second request a received. Responsive to the first request directed to a first user interface element of a first user interface of the deathcare-servicing application, performing a first set of software operations for generating a legally compliant digital form based on a set of ledger entries, including the particular ledger entry, included in the deathcare-servicing ledger. And responsive to a second request directed to a second user interface element of the first user interface, performing a second set of software operations, distinct from the first set of software operations, for modifying particular data associated with the deathcare provider, the particular data associated with a plurality of deathcare-servicing ledgers, including the deathcare-servicing ledger.

(A5) In some implementations of A4, the legally compliant digital form is generated based on a selection of a form template from a set of form templates, wherein the form template is selected from the set of form templates based on a set of form-identification data, including at least particular data corresponding to the particular ledger entry. For example, the user may provide a contract type value into the corresponding field of the first user interface element 462 (e.g., a contract for burial services), and a particular template may be identified based on the value provided for the contract type.

(A6) In some implementations of A5, the form-identification data further includes a location related to the end-of-life event. For example, when the user performs the user input 464 to generate the legally compliant digital form in FIG. 4E, particular aspects of the legally compliant digital form (e.g., required disclosures) may be determined based on a location where the deathcare-servicing items are being purchased and/or provided. And one or more aspects of the preview of the digital form (e.g., the form item 474 of the visual representation 470) may be generated based on the location of the user.

(A7) In some implementations of any one of A4 to A6, the first set of software operations includes instructions for presenting, at a second user interface of the deathcare-servicing application, distinct from the first user interface, a preview of the legally compliant digital form. For example, the form-generation user interface 435 shown in FIG. 4F includes a visual representation 470 that includes a preview of a legally compliant digital form corresponding to the deathcare-servicing items that have been added to the deathcare-servicing ledger 411.

(A8) In some implementations of any one of A4 to A7, the second set of software operations include instructions for determining an accounting of the particular ledger entry by applying one or more accounting principles, from a set of accounting principles associated with the particular data objects corresponding to the deathcare provider. In some implementations, the second set of software operations include instructions for presenting a representation related to the accounting of the particular ledger entry.

(A9) In some implementations of A8, the accounting principles include one or more of: (i) trusting requirements based on additional data about a timing of need of respective deathcare services corresponding to the first item; (ii) taxation requirements based on one or more state laws implicated by contracting for respective deathcare services and/or merchandise corresponding to the first item; and/or a commissioning parameter associated with the request to create the deathcare-servicing ledger for the end-of-life event.

(A10) In some implementations of A9, the accounting principles further include instructions for identifying an amount of a resource to be allotted from the deathcare-servicing ledger to a first accounting ledger of a plurality of accounting ledgers mapped to the deathcare-servicing ledge, and based on the amount of the resource and the other data received about the end-of-life event, determining a subject amount of the resource to store within the first accounting ledger of the plurality of accounting ledgers mapped to the deathcare-servicing ledger.

(A11) In some implementations of any one of A4 to A10, the deathcare-servicing application receives a third request. Responsive to the third request directed to a third user interface element of the first user interface, performing a third set of software operations, distinct from the first and second sets of software operations, for presenting informational representations for each respective ledger entry of the deathcare-servicing ledger.

(A12) In some implementations of any one of A1 to A11, the items include one or more of: (a) a set of deathcare service parameters associated with a particular deathcare service for the end-of-life event, wherein the set of deathcare service parameters include (i) a time frame corresponding to performance of the particular deathcare service, and (ii) a required participant to be available during the time frame; (b) a physical item of merchandise associated with the end-of-life event, wherein the physical item is capable of being provided by the deathcare provider; and/or (c) an available interment right at a physical location associated with the deathcare provider, wherein the available interment right is based on a set of cemetery plots (e.g., spaces within a cemetery garden) owned and/or operated by the deathcare provider. For example, each of the respective deathcare-servicing items shown in FIG. 4B (the deathcare-servicing items 440-1, 440-2, and 440-3) each have a different deathcare-servicing type (e.g., “Service” corresponding to a set of deathcare service parameters associated with a particular deathcare service; “Merchandise” corresponding to a physical item of merchandise; and “Interment” corresponding to an available interment right at a physical location associated with the deathcare provider).

(A13) In some implementations of any one of A1 to A12, before identifying the particular data objects corresponding to the deathcare provider, the deathcare-servicing application determines that the user of the electronic device 102-2 is associated with a first ledger-account holder of a plurality of ledger-account holders associated with the deathcare-servicing application. In some implementations, based on the indication that the user is associated with the first ledger-account holder, the deathcare-servicing application 400 identifies a first ledger-account map, the first ledger-account map configured for mapping respective items of deathcare services and/or merchandise available to be provided by the first ledger-account holder.

(A14) In some implementations of A13, the deathcare-servicing application 400 determines that there is no ledger-account map associated with the first ledger-account holder. In some implementations, the deathcare-servicing application 400 determines a first set of items corresponding to deathcare services configured to be provided by the deathcare provider. In some implementations, based on the first set of items, the deathcare-servicing application 400 generates a default ledger-account map for the ledger-account holder based on the first set of items.

(A15) In some implementations of A14, a vendor type is determined based on the indication that the user is associated with the first ledger-account holder, and the default ledger-account map is generated based on the vendor type associated with the first ledger-account holder. For example, a basic package of funeral services may be provided as a default item based on determining that the vendor logging into the deathcare-servicing application 400 is associated with a funeral home.

(A16) In some implementations of A15, the set of items is identified based on the vendor type. For example, a first set of items may be presented based on a determination that a user logging into the deathcare-servicing application 400 is associated with a first type of vendor (e.g., a cemetery site), and a second set of items may be presented based on a determination that a user logging into the deathcare-servicing application 400 is associated with a second type of vendor (e.g., a funeral home).

(A17) In some implementations of any one of A1 to A16, before receiving the request to create the deathcare-servicing ledger for the end-of-life event, and responsive to a request by the user to configure an item-ledger map within the deathcare-servicing application, the deathcare-servicing application presents an item-ledger mapping user interface, wherein the item-ledger mapping user interface allows the user of the deathcare-servicing application to identify relationships between a particular deathcare service and a plurality of respective potential ledger entries that the particular deathcare service is configured to correspond to, based on particular other data being received.

(A18) In some implementations of any one of A1 to A17, the deathcare-servicing application further includes a cemetery-mapping user interface, the cemetery-mapping user interface configured to allow respective users to identify interment rights to specific spaces (e.g., a plurality of individual plots) within a cemetery site (e.g., a cemetery garden), and the interment rights are configured to be identified using a variable number of descriptors corresponding to physical aspects of respective specific spaces within a cemetery garden. For example, selection of the user interface element 438 may cause selection of a location setup tool for mapping a plurality of different interment rights (e.g., rights to respective locations of a cemetery site). In some implementations, different interment rights mapped to respective locations within the cemetery site may be mapped to sets of descriptors having different numbers of individual descriptors, based on, for example, a preference of the deathcare provider and/or a number of descriptors required to fully specify a unique location with the respective cemetery site. For example, a first location within a mausoleum on the cemetery site may be specified by a first number of descriptors (e.g., seven descriptors), and a second location within a field of the cemetery site may be specified by a second number of descriptors (e.g., four descriptors).

In some implementations, the deathcare-servicing application is configured to output data associated with a created deathcare-servicing ledger, and/or a particular deathcare provider based on information from one or more ledgers entries corresponding to selected deathcare-servicing items associated with end-of-life events. For example, in some implementations, the deathcare-servicing application is configured to output accounting data, based on data from an aggregated set of deathcare-servicing ledgers that were created by a particular deathcare-servicing provider (e.g., all of the deathcare-servicing items that were purchased through a particular funeral home or crematory), in a format such that the data can be used by a different software application having distinct functions from the deathcare-servicing application (e.g., an accounting application, scheduling software, etc.). In accordance with some implementations, the deathcare-servicing application includes a data interface for managing integrations with other software, such that data generated based on usage of the deathcare-servicing application is configured to automatically (e.g., in real time, without further user input) flow through the data interface to the other application.

In some implementations, the operations illustrated by the FIGS. 4A to 4G are capable of being performed by a particular set of software components (e.g., a development stack), such as Vue.js, React.js, C sharp, and/or HTML. In some implementations, one or more of the operations described herein can be performed entirely by a front-end script execution engine of a general-purpose web browser. In some implementations, one or more operations can be performed within a public-facing web portal of a web domain (e.g., a self-service customer portal).

Although the Example Embodiments depicted by the method 500 include a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

It will also be understood that, although the terms first, second, etc., are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not the same electronic device.

The terminology used in the description of the various implementations described herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/of” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method, comprising:
at an electronic device associated with a deathcare provider, the electronic device having one or more processors and memory, the memory storing instructions for causing presentation of a deathcare-servicing application:
receiving a request to create a deathcare-servicing ledger for an end-of-life related event;
in accordance with receiving the request, identifying particular data objects corresponding to the deathcare provider;
based on the particular data objects identified as corresponding to the deathcare provider, identifying a set of items for selection by a user of the electronic device, wherein the set of items correspond to available deathcare service and/or merchandise items related to the end-of-life event;
responsive to a selection, by the user, of a first item of the set of items, identifying a particular ledger entry from a plurality of ledger entries mapped to the first item, wherein the particular ledger entry is identified based on other data received by the electronic device about the end-of-life event; and
providing the particular ledger entry to the deathcare-servicing ledger for the end-of-life event, wherein the deathcare-servicing ledger is configured to identify information relevant to performing all of a set of deathcare-servicing software operations for coordinating fulfillment of the selection of the available deathcare service and/or merchandise items related to the end-of-life event.

2. The method of claim 1, wherein:
the other data received via the electronic device about the end-of-life event includes an indication whether the end-of-life event has occurred, or is yet to occur; and
in accordance with a first indication that the end-of-life event has not yet occurred:
the particular ledger entry is identified as a pre-need ledger entry corresponding to a respective end-of-life event that has yet to occur; and
identification of a different ledger entry mapped to the first item, identified as an at-need ledger entry, is forgone.

3. The method of claim 2, further comprising:
receiving audio data corresponding to a first call, from a third-party such as a coroner, related to another end-of-life event; and
providing, based on the received audio data, a second indication that the other end-of-life event has already occurred to a different deathcare-servicing ledger associated with the other end-of-life event.

4. The method of claim 1, further comprising, after the particular ledger entry has been provided to the deathcare-servicing ledger:
responsive to a first request directed to a first user interface element of a first user interface of the deathcare-servicing application, performing a first set of software operations for generating a legally compliant digital form based on a set of ledger entries, including the particular ledger entry, included in the deathcare-servicing ledger; and
responsive to a second request directed to a second user interface element of the first user interface, performing a second set of software operations, distinct from the first set of software operations, for modifying particular data associated with the deathcare provider, the particular data associated with a plurality of deathcare-servicing ledgers, including the deathcare-servicing ledger.

5. The method of claim 4, wherein:
the legally compliant digital form is generated based on a selection of a form template from a set of form templates, wherein the form template is selected from the set of form templates based on a set of form-identification data, including at least particular data corresponding to the particular ledger entry.

6. The method of claim 5, wherein the form-identification data further includes a location related to the end-of-life event.

7. The method of claim 4, wherein the first set of software operations include instructions for:
presenting, at a second user interface of the deathcare-servicing application, distinct from the first user interface, a preview of the legally compliant digital form.

8. The method of claim 4, wherein the second set of software operations include instructions for:
determining an accounting of the particular ledger entry by applying one or more accounting principles, from a set of accounting principles associated with the particular data objects corresponding to the deathcare provider; and
presenting a representation related to the accounting of the particular ledger entry.

9. The method of claim 8, wherein the accounting principles include one or more of:
trusting requirements based on additional data about a timing of need of respective deathcare services corresponding to the first item;
taxation requirements based on one or more state laws implicated by contracting for respective deathcare services and/or merchandise corresponding to the first item; and/or
a commissioning parameter associated with the request to create the deathcare-servicing ledger for the end-of-life event.

10. The method of claim 9, wherein the accounting principles further include instructions for:
identifying an amount of a resource to be allotted from the deathcare-servicing ledger to a first accounting ledger of a plurality of accounting ledgers mapped to the deathcare-servicing ledger; and
based on the amount of the resource and the other data received about the end-of-life event, determining a subject amount of the resource to store within the first accounting ledger of the plurality of accounting ledgers mapped to the deathcare-servicing ledger for the end-of-life event.

11. The method of claim 4, further comprising:
responsive to a third request directed to a third user interface element of the first user interface, performing a third set of software operations, distinct from the first and second sets of software operations, for presenting informational representations for each respective ledger entry of the deathcare-servicing ledger.

12. The method of claim 1, wherein the items include one or more of:
a set of deathcare service parameters associated with a particular deathcare service for the end-of-life event, wherein the set of deathcare service parameters include (i) a time frame corresponding to performance of the particular deathcare service, and (ii) a required participant to be available during the time frame;
a physical item of merchandise associated with the end-of-life event, wherein the physical item is capable of being provided by the deathcare provider; and/or
an available interment right at a physical location associated with the deathcare provider, wherein the available interment right is based on a set of cemetery plots owned or operated by the deathcare provider.

13. The method of claim 1, further comprising:
before identifying the particular data objects corresponding to the deathcare provider, determining that the user is associated with a first ledger-account holder of a plurality of ledger-account holders associated with the deathcare-servicing application; and
based on the indication that the user is associated with the first ledger-account holder, identifying a first ledger-account map, the first ledger-account map configured for mapping respective items of deathcare services available to be provided by the first ledger-account holder.

14. The method of claim 13, further comprising:
in accordance with determining that there is no ledger-account map associated with the first ledger-account holder;
determining a first set of items corresponding to deathcare services configured to be provided by the deathcare provider; and
based on the first set of items, generating a default ledger-account map for the first ledger-account holder based on the first set of items.

15. The method of claim 14, wherein:
a vendor type is determined based on the indication that the user is associated with the first ledger-account holder; and
the default ledger-account map is generated based on the vendor type associated with the first ledger-account holder.

16. The method of claim 15, wherein the set of items is identified based on the vendor type.

17. The method of claim 1, further comprising:
before receiving the request to create the deathcare-servicing ledger for the end-of-life event, and responsive to a request by the user to configure an item-ledger map within the deathcare-servicing application:
presenting an item-ledger mapping user interface, wherein the item-ledger mapping user interface allows the user of the deathcare-servicing application to identify relationships between a particular deathcare service and a plurality of respective potential ledger entries that the particular deathcare service is configured to correspond to, based on particular other data being received.

18. The method of claim 1, wherein:
the deathcare-servicing application further includes a cemetery-mapping user interface, the cemetery-mapping user interface configured to allow respective users to identify interment rights to a plurality of plots within a cemetery site, and
the interment rights are configured to be identified using a variable number of descriptors corresponding to physical aspects of respective plots of the plurality of plots within the cemetery site.

19. A computing device, comprising:
one or more processors; and
memory, comprising instructions, which, when executed by the one or more processors, cause operations for:
at an electronic device associated with a deathcare provider, the electronic device having one or more processors and memory, the memory storing instructions for causing presentation of a deathcare-servicing application:
receiving a request to create a deathcare-servicing ledger for an end-of-life event;
in accordance with receiving the request, identifying particular data objects corresponding to the deathcare provider;
based on the particular data objects identified as corresponding to the deathcare provider, identifying a set of items for selection by a user of the electronic device, wherein the set of items correspond to available deathcare service items for the end-of-life event;
responsive to a selection, by the user, of a first item of the set of items, identifying a particular ledger entry from a plurality of ledger entries mapped to the first item, wherein the particular ledger entry is identified based on other data received by the electronic device about the end-of-life event; and
providing the particular ledger entry to the deathcare-servicing ledger for the end-of-life event, wherein the deathcare-servicing ledger is configured to identify information relevant to performing all of a set of deathcare-servicing software operations for coordinating fulfillment of the selection of the available deathcare service items for the end-of-life event.

20. A non-transitory, computer-readable storage medium comprising instructions, which, when executed by an electronic device associated with a deathcare provider, the electronic device having one or more processors and memory, the memory storing instructions for causing presentation of a deathcare-servicing application, cause operations for:
receiving a request to create a deathcare-servicing ledger for an end-of-life event;
in accordance with receiving the request, identifying particular data objects corresponding to the deathcare provider;
based on the particular data objects identified as corresponding to the deathcare provider, identifying a set of items for selection by a user of the electronic device, wherein the set of items correspond to available deathcare service items for the end-of-life event;
responsive to a selection, by the user, of a first item of the set of items, identifying a particular ledger entry from a plurality of ledger entries mapped to the first item, wherein the particular ledger entry is identified based on other data received by the electronic device about the end-of-life event; and
providing the particular ledger entry to the deathcare-servicing ledger for the end-of-life event, wherein the deathcare-servicing ledger is configured to identify information relevant to performing all of a set of deathcare-servicing software operations for coordinating fulfillment of the selection of the available deathcare service and/or merchandise items related to the end-of-life event.
